(19) United States
(12) Patent Application Publication
(10) Pub. No.: US 2016/0035047 A1
(43) Pub. Date: Feb. 4, 2016

(54) Managing Energy Meter Usage Feedback

(71) Applicants: International Business Machines Corporation, Armonk, NY (US); Universiti Brunei Darussalam, Gadong (BN)

(72) Inventors: Zainul M. Charbiwala, Nagawara (IN); Tanuja H. Ganu, Nagawara (IN); Harshad D. Khadilkar, Nagawara (IN); Ming Chee Lim, Gadong (BN); Devasenapathi P. Seetharamakrish, Nagawara (IN)

(73) Assignees: International Business Machines Corporation, Armonk, NY (US); Universiti Brunei Darussalam, Tungku Link (BN)

(21) Appl. No.: 14/446,724

(22) Filed: Jul. 30, 2014

(51) Int. Cl. G06Q 50/06; G06Q 20/02; G06Q 20/28; G06Q 20/38

(52) U.S. Cl. CPC G06Q 50/06; G06Q 20/3829; G06Q 20/02; G06Q 20/28

(57) ABSTRACT

Methods, systems, and computer program products for managing energy meter usage feedback are provided herein. A method includes detecting information generated by a prepaid energy meter that has been authorized for a given user; processing the detected information to determine an amount of energy consumption associated with the prepaid energy meter; generating a code based on said processing comprising encrypting (i) the determined amount of energy consumption, (ii) an identifier corresponding to the prepaid energy meter, and (iii) authentication information for the given user authorized to to use the prepaid energy meter; outputting the generated code for transmission to an energy provider associated with the prepaid energy meter; decrypting a recharge code for the prepaid energy meter received in response to validation of the generated code by the energy provider associated with the prepaid energy meter; and enabling a remote recharge operation of the prepaid energy meter based on said decrypting.

### FIELD OF THE INVENTION

Embodiments of the invention generally relate to information technology, and, more particularly, to energy consumption information.

### BACKGROUND

Prepaid energy meters have been implemented in many parts of the world because of the financial and operational conveniences such meters offer to utilities. Namely, prepaid energy meters require a customer to make advance payment(s) before the customer can gain access to or utilize corresponding energy. However, despite the noted conveniences, utilities also commonly find that the lack of physical visits by utility personnel to prepaid meters often leads to increased occurrences of energy theft.

In response, many utilities implement and utilize cryptographic tokens in an attempt to prevent theft. In such approaches, a token is generated based on a customer's meter number, and transactions related thereto are logged in the utility's central database. However, such approaches encounter multiple problems and challenges. For example, tokens can be compromised, and/or security modules can be stolen or fabricated and used to provide illegal tokens. Also, in such approaches, consumption data cannot be collected by the utility for potential further analysis.

Postpaid energy meters, by contrast, require site visits by utility personnel at the end of every billing cycle, which is a labor-intensive process. In such visits, the total energy consumed over the course of the billing cycle is noted and charges are computed accordingly. However, this procedure does not enable the utility to receive detailed temporal consumption information about its subscribers. This omission hampers the detection of potential wrongdoers through an analysis of related consumption data.

Accordingly, a need exists for techniques to track and authenticate energy consumption by a consumer via an energy meter using code generated from the meter. Such techniques will allow the utilities to log details about subscriber energy consumption without the need for installation of expensive smart meters or the need for physical site visits.

### SUMMARY

In one aspect of the present invention, techniques for managing energy meter usage feedback are provided. An exemplary computer-implemented method can include steps of detecting information over a specified period of time, via an optical sensor, the information being generated by a prepaid energy meter that has been authorized for a given user; processing the detected information to determine an amount of energy consumption associated with the prepaid energy meter over the specified period of time; generating a code based on said processing, wherein said generating comprises encrypting (i) the determined amount of energy consumption, (ii) an identifier corresponding to the prepaid energy meter, and (iii) authentication information for the given user authorized to use the prepaid energy meter; outputting the generated code for transmission to an energy provider associated with the prepaid energy meter; decrypting a recharge code for the prepaid energy meter received in response to validation of the generated code by the energy provider associated with the prepaid energy meter; and enabling a remote recharge operation of the prepaid energy meter based on said decrypting.

In another aspect of the invention, an exemplary computer-implemented method can include steps of decrypting a first code transmitted in connection with a recharge operation request for a prepaid energy meter; comparing the decrypted first code to the contents of a database to validate the decrypted first code as being authenticated to (i) the prepaid energy meter and (ii) a given user authorized to use the prepaid energy meter; encrypting a second code for recharging the prepaid energy meter based on validation of the decrypted first code; and outputting the encrypted second code for transmission to the prepaid energy meter.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps.

Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an example embodiment, according to an aspect of the invention;

FIG. 2 is a block diagram illustrating an example embodiment, according to an aspect of the invention;

FIG. 3 is a flow diagram illustrating techniques according to an embodiment of the invention;

FIG. 4 is a flow diagram illustrating techniques according to an embodiment of the invention; and

FIG. 5 is a system diagram of an exemplary computer system on which at least one embodiment of the invention can be implemented.

### DETAILED DESCRIPTION

As described herein, an aspect of the present invention includes managing energy meter usage feedback. At least one embodiment of the invention includes a combination of (i) a hardware device that tracks consumption and (ii) a recharge mechanism combined with back-end analytics that deters and/or limits potential theft. The hardware device can be added to new or existing prepaid (as well as post-paid) energy meters. As described herein, the hardware device can be user-installable, thereby precluding the need for utility personnel to be involved in the installation process. Additionally, while much of the description herein is in connection with prepaid energy meters, it should be appreciated that such descriptions are illustrative examples and that additional embodiments, including those implemented within the context of post-paid meters, are to be encompassed by the descriptions herein as well.

As also described herein, the hardware device noted above can include multiple components including a memory component for storing information such as pulse time stamps. Such a memory component can be housed, for example, in a casing for protection from deliberate magnetic interference. The hardware device can also include an optical sensor and/or reader for detecting and processing information generated by an energy meter, wherein such detection can include, for example, counting light pulses emitted by the meter every time a certain quantum of energy is consumed. Additionally, the hardware device can include a computing chip for encoding information (and a corresponding software component to implement an encoding scheme for consumption data), as well as a code display and/or audio code modulator with a speaker component.

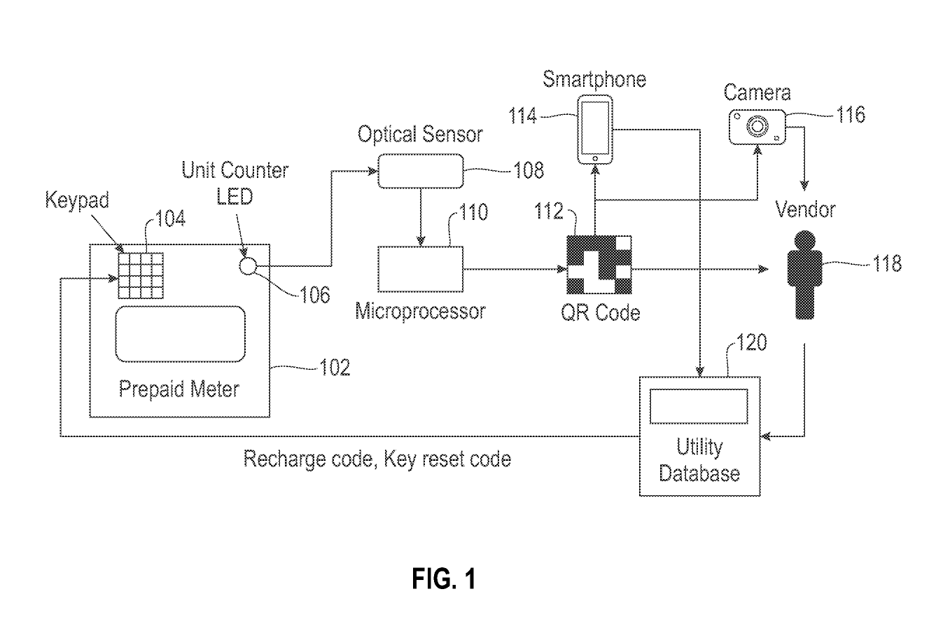

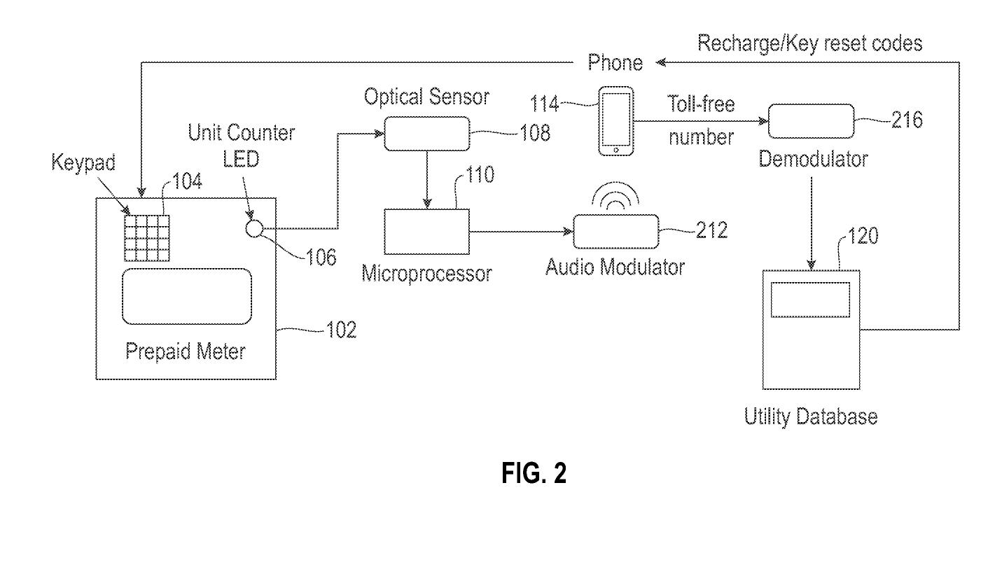

As further described herein, an aspect of the invention includes creation and implementation of a generated code that enables two-way communication between an energy meter and the utility without the need for explicit communication infrastructure. As depicted in the example illustrated in FIG. 1 (and FIG. 2), the hardware components (such as the optical sensor, the microprocessor, etc.) can be independent devices (that is, they do not need to belong to a single hardware device) in one or more embodiments of the invention. However, it is noted that this illustration is merely one example, and it is to be appreciated by one skilled in the art that the described hardware components can, in accordance with one or more embodiments of the invention, be packaged as a single device.

Also, as noted above, the software component performs encoding and encryption of the information to be transmitted into a visual and/or audio code, as further detailed herein. Additionally, a software component as existing on the back-end (the utility) can also decode the information received from the hardware components and generate an authentication token. In a prepaid meter scheme, this token will contain authorization for the meter to supply an additional amount of electricity to the user. In a postpaid meter to scheme, the token will contain authorization to continue service through the next billing cycle. It is envisioned, for example, that in the postpaid scheme, the utility will discontinue service in the event that the consumer does not regularly generate an authentication token within a certain time period.

Additionally, one or more embodiments of the invention can include transmitting a generated visual code that identifies a given energy meter and energy consumption data related thereto to a utility database. Such transmission can be carried out, for example, through existing communication infrastructure (such as smart phones with a data connection) and/or through a bespoke communication mechanism, with the purpose of generating an authentication token after the visual code is successfully logged. A code for recharging the meter (in the case of a prepaid mechanism, for example) or a code for allowing continued service (in the case of a postpaid mechanism, for example) can be embedded in the authentication token through any suitable encryption scheme. Further, such an authentication token may be manually entered by the consumer into the meter, or may be automatically conveyed through the same mechanism that generates the code. As also described herein, multiple implementation techniques and options can be utilized with one or more embodiments of the invention. For example, one such implementation option includes a hardware retrofit, wherein a hardware device such as described herein is attached (for example, clamped-on) to an existing energy meter. Such an option can be carried out via self-installation, for example. Another implementation option includes a hardware retrofit with a software update, wherein a hardware device such as described herein is attached to an existing energy meter and the meter software is updated to accept only the new token scheme corresponding to the attached hardware device. Such an implementation option can additionally include periodic and/or regular changes to encryption keys, and key reset information can be embedded in recharge codes.

Accordingly, at least one embodiment of the invention includes implementing an encryption mechanism which allows only the meter and the utility to decode information transmitted by each other. As such, without the encryption keys, the messages to and/or from the meter cannot be interpreted even if intercepted. Also, a key reset code may be transmitted periodically from the meter to the utility or vice versa, wherein such a code changes the encryption key; a process similar, for example, to changing the password for one's email account.

Yet another implementation option includes installation of a new meter, wherein the new meter would include embedded hardware and software configured to carry out aspects of the present invention. In such an embodiment, the embedded hardware can prevent a recharge operation via a previous token scheme. Also, such an implementation option can additionally include periodic and/or regular changes to encryption keys, and key reset information can be embedded in recharge codes.

At least one embodiment of the invention facilitates consumer self-reporting of his or her energy consumption through optical and/or audio mechanisms. By way of example, the consumer can use his or her smart phone to take a picture of an optical code such as a quick response (QR) code, or hold up his or her smart phone to the hardware device when connected to a utility (for instance, connected via a phone call). The corresponding server, upon accepting the data (from the consumer smart phone, for example), generates an authentication token that can be used to recharge the meter. By analyzing the data for one or more patterns, theft attack vectors can be successfully identified and prevented. The requirement to connect to the utility directly (such as through a phone call to a published number) itself deters theft occurring through the use of stolen and/or compromised vendor-owned authentication equipment.

At least one embodiment of the invention includes tracking energy consumption by a given consumer using code generated from an energy meter corresponding to the given consumer, wherein the code represents authentication of the given consumer, consumption information associated with the given consumer, and verification of consumption information generated by the energy meter. By way of example, such an embodiment can include verifying readings of an energy meter by monitoring a pulse produced by a source such as a light-emitting diode (LED) using an optical sensor, wherein the pulse is generated upon consumption of each specified energy unit. Also, as detailed herein, an example embodiment of the invention can include recharging a given energy meter for prepaid usage using a QR code or audio modulated signal that is generated from the given energy meter.

Accordingly, aspects of the invention include enabling communication of high-resolution consumption information (for example, quantity of energy consumed every minute) from a given energy meter to the utility, detecting and/or deterring theft occurring through illegal prepaid transactions, and precluding the need for meter replacement and additional communication infrastructure. Detecting theft can include, by way of example, authentication of recharge coupons as well as through meter analytics, in the case of meter tampering. Also, precluding the need for additional communication infrastructure results, in part, from one or more embodiments of the invention implementing and enabling remote recharge of a given energy meter, wherein the recharge can be carried out (approximately instantaneously) by the consumer from his or her place of residence (or business, etc.), either using the internet (in connection with a visual code, for example) or over a phone call (in connection with an audio implementation).

FIG. 1 is a block diagram illustrating an example embodiment, according to an aspect of the invention. By way of illustration, FIG. 1 depicts a QR code implementation that includes a prepaid meter 102, an optical sensor 108, a microprocessor 110, a QR code 112, a smart phone 114, a camera component 116, a vendor entity 118 and a utility database 120. As also depicted, the prepaid meter 102 includes a keypad component 104 and a unit counter LED component 106. Note that the example of a QR code is used herein for illustrative purposes only, and that it should be appreciated by one skilled in the art that any visual code that is machine readable can be substituted and/or used in the described mechanism.

Accordingly, in an embodiment of the invention such as depicted in FIG. 1, the LED component 106 of the prepaid meter 102 flashes once for each unit of energy consumed. The optical sensor 108 detects these LED flashes from the LED component 106 of the prepaid meter 102, and such detected information is processed by the microprocessor 110 (which is in communication with the optical sensor 108). The microprocessor 110 then generates the QR code 112, which is embedded with an identifier corresponding to the prepaid meter 102 and consumption information, and a distinct QR code is generated for each prepaid recharge operation.

By way of example, one or more embodiments of the invention can employ one of multiple methods for transmitting the QR code 112 to the utility database 120. In one such method, the consumer may use a smart phone 114 to read the QR code 112 and transmit the same to the utility database 120 via a cellular data network. This mechanism can be completed, for example, from within the consumer's premises, and obviates the necessity of visiting a vendor for a recharge.

In a second transmission method, the consumer may take a picture of the QR code 112 using a camera phone 116 and provide this picture to a vendor 118. The vendor 118 can then, for example, scan the photograph of the QR code 112 and transmit the scanned code to the utility database 120. In a third transmission method, the consumer can provide a physical printout of the QR code 112 to the vendor 118, following which the vendor 118 can scan the QR code 112 and transmit the scanned code to the utility database 120.

Following successful execution of a transmission mechanism (such as one of the methods described above), the utility database 120 stores the received information. A software component can also validate the received information. Should the received information be deemed valid, the utility can generate a recharge code and/or a new encryption key for the meter 102. All information to be sent to the meter 102 can be encoded into a single message (such as, for example, a stream of digits) and sent to the meter 102 using a direct communication mechanism and/or as a text message to the consumer's registered cellular phone number. This message may then be entered by the consumer into the energy meter 102 for recharging the said energy meter. Alternatively, the authentication message can itself be a QR code that is automatically read by a sensor on the meter.

FIG. 2 is a block diagram illustrating an example embodiment, according to an aspect of the invention. By way of illustration, and as further described herein, FIG. 2 depicts an audio modulation implementation that includes a prepaid meter 102, an optical sensor 108, a microprocessor 110, an audio modulator component 212, a phone 114, a demodulator component 216, and utility database 120. Similar to FIG. 1, the prepaid meter 102 additionally includes a keypad component 104 and a unit counter LED component 106.

Accordingly, in an embodiment of the invention such as depicted in FIG. 2, the LED component 106 of the prepaid meter 102 flashes once for each unit of energy consumed. The optical sensor 108 detects these LED flashes from the LED component 106 of the prepaid meter 102, and such detection information is processed by the microprocessor 110 (which is in communication with the optical sensor 108). The microprocessor 110 then communicates with the audio modulator component 212, which generates an audio code embedded with an identifier corresponding to the prepaid meter 102 and consumption information. Additionally, such audio code is generated for each prepaid recharge operation. The phone 114 connects to the utility (for example, via a toll-free number) and relays the audio code to the demodulator component 216 using, for example, modem-like technology. This mechanism can be completed, for example, from within the consumer's premises, and obviates the necessity of visiting a vendor for a recharge.

Subsequently, the demodulator component 216 communicates with the utility database 120 and consumption information is logged in the utility database 120, the given transaction is processed, and a recharge code and/or a new encryption key is sent (for example, via text or audio) to the phone 114 as a single encoded message (such as a stream of digits, for example). By way of example, a text message to the phone 114 can convey a transaction failure in the case of a noisy channel. In such an instance, the user can retry the recharge process. This message can then be entered by the consumer into the energy meter 102 for recharging the energy meter. Alternatively, the authentication message may be another audio code that is played back by the user's phone and received by a microphone located on the meter. Should direct communication infrastructure from the database 120 to the meter 102 exist, the utility may also send this message directly to the meter.

In one or more embodiments of the invention, such as those depicted in FIG. 1 and FIG. 2, an encoding scheme is implemented that includes discretizing time into intervals of length ΔT and energy into quanta of size E watt-hours. By way of example, a threshold can be pre-set as one bit for every ΔT, resulting in a value of one if one or more LED flashes are detected, and resulting in a value of zero otherwise. Additionally, one or more embodiments of the invention include ensuring that the value of ΔT is large enough for the probability of two flashes within one time period to be sufficiently small. This will need to be ensured based upon the expected peak rate of consumption for a given (or representative) consumer. Further, in at least one embodiment of the invention, ΔT can be adaptive and/or can be based on remaining available memory.

As noted above, while FIG. 1 and FIG. 2 illustrate example embodiments of the invention implemented in connection with prepaid energy meters, it should be appreciated that such embodiments are merely examples and that additional embodiments can be implemented in connection with post-paid meters. The techniques detailed herein in connection with prepaid meter embodiments can be implemented in connection with a post-paid energy meter, while such an embodiment can also include the incorporation of a machine readable meter display with optical sensor.

An aspect of the invention includes generating and providing higher-resolution data than, for example, standard monthly and/or quarterly consumption reports found commonly in existing approaches. Accordingly, one or more embodiments of the invention include generating and providing time-stamped consumption details at a given or pre-specified interval. As detailed herein, such time-stamped consumption information can be used for anomaly and/or theft detection.

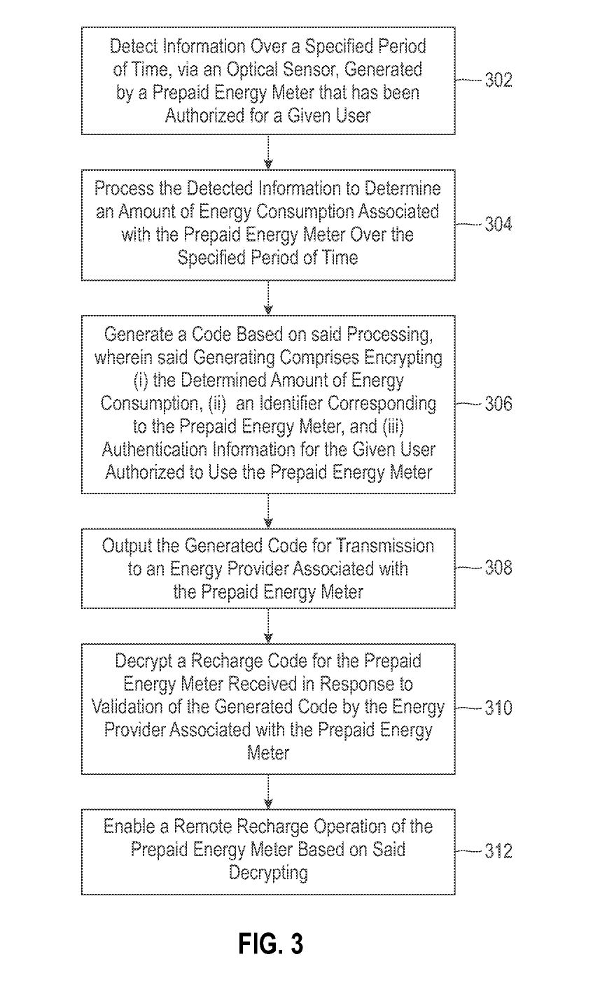

FIG. 3 is a flow diagram illustrating techniques according to an embodiment of the present invention. Step 302 includes detecting information over a specified period of time, via an optical sensor, the information being generated by a prepaid energy meter that has been authorized for a given user. Step 304 includes processing the detected information to determine an amount of energy consumption associated with the prepaid energy meter over the specified period of time.

Step 306 includes generating a code based on said processing, wherein said generating comprises encrypting (i) the determined amount of energy consumption, (ii) an identifier corresponding to the prepaid energy meter, and (iii) authentication information for the given user authorized to use the prepaid energy meter. In at least one embodiment of the invention, the generated code can be a generated audio code or a generated visual code, such as a QR code and/or a camera-readable code.

Step 308 includes outputting the generated code for transmission to an energy provider associated with the prepaid energy meter. Outputting can include, for example, outputting a generated visual code via a display component, as well as outputting a generated audio code via a speaker component. Additionally, transmission to the energy provider can include, for example, transmission via a cellular data network, transmission to the energy provider through a third party vendor, and/or transmission through a bespoke communication mechanism.

Step 310 includes decrypting a recharge code for the prepaid energy meter received in response to validation of the generated code by the energy provider associated with the prepaid energy meter. Step 312 includes enabling a remote recharge operation of the prepaid energy meter based on said decrypting.

The techniques depicted in FIG. 3 can also include encrypting an encryption key reset code for the energy provider associated with the prepaid energy meter and outputting for the encryption key reset code for transmission to the energy provider associated with the prepaid energy meter. Further, at least one embodiment of the invention includes decrypting an encryption key reset code for the prepaid energy meter received from the energy provider associated with the prepaid energy meter.

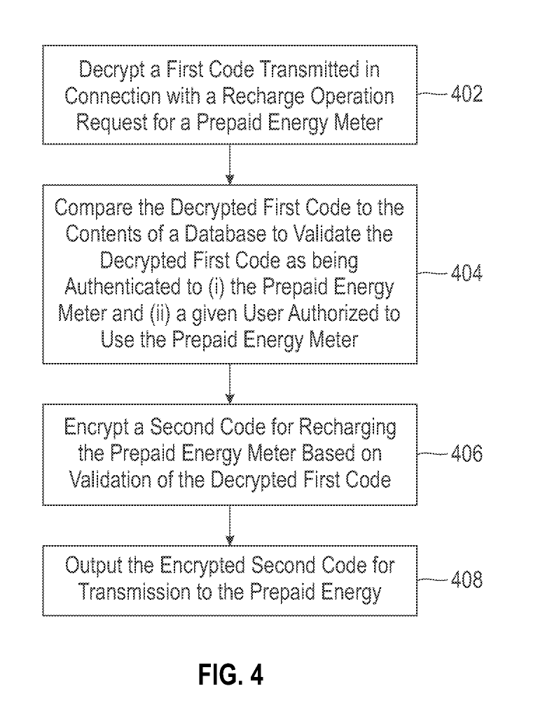

FIG. 4 is a flow diagram illustrating techniques according to an embodiment of the invention. Step 402 includes decrypting a first code transmitted in connection with a recharge operation request for a prepaid energy meter. Step 404 includes comparing the decrypted first code to the contents of a database to validate the decrypted first code as being authenticated to (i) the prepaid energy meter and (ii) a given user authorized to use the prepaid energy meter.

Step 406 includes encrypting a second code for recharging the prepaid energy meter based on validation of the decrypted first code. Step 408 includes outputting the encrypted second code for transmission to the prepaid energy meter. Outputting can include outputting the encrypted second code directly to the prepaid energy meter and/or outputting the encrypted second code to the given user for manual transmission to the prepaid energy meter.

The techniques depicted in FIG. 4 can also include encrypting a third code for resetting an encryption key and outputting the encrypted third code for transmission to the prepaid energy meter. At least one embodiment of the invention can additionally include decrypting a fourth code for resetting an encryption key received from the prepaid energy meter. Further, at least one embodiment of the invention includes storing the decrypted code in the database.

The techniques depicted in FIG. 3 and FIG. 4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 and FIG. 4 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

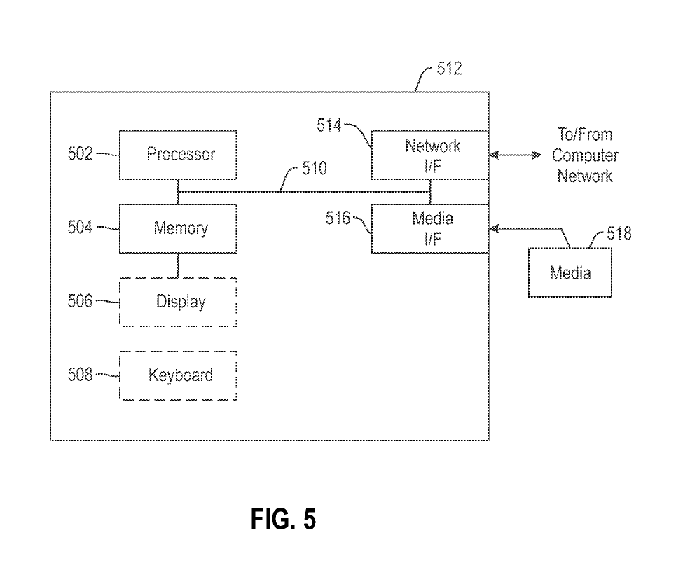

Additionally, an aspect of the present invention can make use of software running on a general purpose computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like.

In addition, the phrase “input/output interface” as used herein, is intended to include, for example, a mechanism for inputting data to the processing unit (for example, a mouse or keypad), and a mechanism for providing results associated with the processing unit (for example, a printer or monitor). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

As will be appreciated by one skilled in the art, aspects of the present invention may be embodied as a system, method and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, as noted herein, aspects of the present invention may take the form of a computer program product that may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable to compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, tracking and recharging an energy meter using a QR code or audio modulated signal.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting information over a specified period of time, via an optical sensor, the information being generated by a prepaid energy meter that has been authorized for a given user;
processing the detected information to determine an amount of energy consumption associated with the prepaid energy meter over the specified period of time;
generating a code based on said processing, wherein said generating comprises encrypting (i) the determined amount of energy consumption, (ii) an identifier corresponding to the prepaid energy meter, and (iii) authentication information for the given user authorized to use the prepaid energy meter;
outputting the generated code for transmission to an energy provider associated with the prepaid energy meter;
decrypting a recharge code for the prepaid energy meter received in response to validation of the generated code by the energy provider associated with the prepaid energy meter; and
enabling a remote recharge operation of the prepaid energy meter based on said decrypting.

2. The method of claim 1, wherein the generated code comprises a generated visual code.

3. The method of claim 2, wherein said generated visual code comprises a quick response (QR) code.

4. The method of claim 2, wherein said generated visual code comprises a camera-readable code.

5. The method of claim 2, wherein said outputting comprises outputting the generated visual code via a display component.

6. The method of claim 1, wherein the generated code comprises a generated audio code.

7. The method of claim 6, wherein said outputting comprises outputting the generated audio code via a speaker component.

8. The method of claim 1, wherein said transmission to the energy provider comprises transmission via a cellular data network.

9. The method of claim 1, wherein said transmission to the energy provider comprises transmission to the energy provider through a third party vendor.

10. The method of claim 1, wherein said transmission to the energy provider comprises transmission through a bespoke communication mechanism.

11. The method of claim 1, comprising:
encrypting an encryption key reset code for the energy provider associated with the prepaid energy meter; and
outputting for the encryption key reset code for transmission to the energy provider associated with the prepaid energy meter.

12. The method of claim 1, comprising:
decrypting an encryption key reset code for the prepaid energy meter received from the energy provider associated with the prepaid energy meter.

13. A computer program product, the computer program product comprising a computer readable storage medium having program instructions embodied therewith, the program instructions executable by a computing device to cause the computing device to:
detect information over a specified period of time, via an optical sensor, the information being generated by a prepaid energy meter that has been authorized for a given user;
process the detected information to determine an amount of energy consumption associated with the prepaid energy meter over the specified period of time;
generate a code based on said processing, wherein said generating comprises encrypting (i) the determined amount of energy consumption, (ii) an identifier corresponding to the prepaid energy meter, and (iii) authentication information for the given user authorized to use the prepaid energy meter;
output the generated code for transmission to an energy provider associated with the prepaid energy meter;
decrypt a recharge code for the prepaid energy meter received in response to validation of the generated code by the energy provider associated with the prepaid energy meter; and
enable a remote recharge operation of the prepaid energy meter based on said decrypting.

14. A system comprising:
a memory; and
at least one processor coupled to the memory and configured for:
detecting information over a specified period of time, via an optical sensor, the information being generated by a prepaid energy meter that has been authorized for a given user;
processing the detected information to determine an amount of energy consumption associated with the prepaid energy meter over the specified period of time;
generating a code based on said processing, wherein said generating comprises encrypting (i) the determined amount of energy consumption, (ii) an identifier corresponding to the prepaid energy meter, and (iii) authentication information for the given user authorized to use the prepaid energy meter;
outputting the generated code for transmission to an energy provider associated with the prepaid energy meter;
decrypting a recharge code for the prepaid energy meter received in response to validation of the generated code by the energy provider associated with the prepaid energy meter; and
enabling a remote recharge operation of the prepaid energy meter based on said decrypting.

15. A method comprising:
decrypting a first code transmitted in connection with a recharge operation request for a prepaid energy meter;
comparing the decrypted first code to the contents of a database to validate the decrypted first code as being authenticated to (i) the prepaid energy meter and (ii) a given user authorized to use the prepaid energy meter;
encrypting a second code for recharging the prepaid energy meter based on validation of the decrypted first code; and
outputting the encrypted second code for transmission to the prepaid energy meter.

16. The method of claim 15, wherein said outputting comprises outputting the encrypted second code directly to the prepaid energy meter.

17. The method of claim 15, wherein said outputting comprises outputting the encrypted second code to the given user for manual transmission to the prepaid energy meter.

18. The method of claim 15, comprising:
encrypting a third code for resetting an encryption key; and
outputting the encrypted third code for transmission to the prepaid energy meter.

19. The method of claim 15, comprising:
decrypting a fourth code for resetting an encryption key received from the prepaid energy meter.

20. The method of claim 15, comprising:
storing the decrypted code in the database.
